(19) United States
(12) Patent Application Publication
(10) Pub. No.: US 2013/0240622 A1
(43) Pub. Date: Sep. 19, 2013

(54) FACILITATING MOBILE DEVICE PAYMENTS USING MOBILE PAYMENT ACCOUNT, MOBILE BARCODE AND UNIVERSAL DIGITAL MOBILE CURRENCY

(71) Applicants: Andrew H. B. Zhou, Tiburon, CA (US); Tiger T. G. Zhou, Tiburon, CA (US); Dylan T. X. Zhou, San Gabriel, CA (US)

(72) Inventors: Andrew H. B. Zhou, Tiburon, CA (US); Tiger T. G. Zhou, Tiburon, CA (US); Dylan T. X. Zhou, San Gabriel, CA (US)

(21) Appl. No.: 13/875,311

(22) Filed: May 2, 2013

Related U.S. Application Data
(63) Continuation-in-part of application No. 13/185,491, filed on Jul. 18, 2011.
Application No. 13/185,491 is a continuation-in-part of application No. 13/620,775, filed on Sep. 15, 2012.

(51) Int. Cl. G06Q 20/10

(52) U.S. Cl. CPC G06Q 20/105; G06Q 20/367
USPC 235/379

(57) ABSTRACT

Provided are computer implemented methods and systems for facilitating mobile device payments using a mobile payment account. When a user is ready to tender a payment to a merchant, instead of using a credit card, cash, or check, the user activates on his mobile device an application associated with a mobile payment account of the user. The mobile payment account is associated with user information and with a mobile payment service provider. The mobile device generates a payment barcode that encodes data of the mobile payment account and displays the payment barcode on a display. After scanning the displayed barcode by a barcode scanner of the merchant, the mobile payment account of the user may be charged.

### CROSS-REFERENCE TO RELATED APPLICATIONS

This application is a Continuation-In-Part of U.S. patent application Ser. No. 13/620,775, filed on Sep. 15, 2012, titled “METHODS AND SYSTEMS FOR FACILITATING MOBILE DEVICE PAYMENTS USING CODES AND CASHBACK BUSINESS MODEL” and U.S. patent application Ser. No. 13/185,491, filed on Jul. 18, 2011, titled “FACILITATING MOBILE DEVICE PAYMENTS USING PRODUCT CODE SCANNING” which are incorporated herein by reference in its entirety for all purposes.

### FIELD

This application relates generally to payment methods using mobile devices in various retail environments and, more specifically, to computer implemented methods and systems facilitating mobile device payments using mobile payment accounts.

### BACKGROUND

When customers buy product items from various merchants in retails environments, such as retail outlets, shopping centers, stores, and so forth, only a handful of payment methods is available to the customers. Typical examples include credit cards, debit cards, gift cards, checks, and cash. Each one of these payment methods has some drawbacks from cost and/or convenience perspectives. For example, checks and cash transactions are slow and require additional processing and/or handling. All these drawbacks interfere with retail transactions and add some level of dissatisfaction. The credit or debit cards are associated with a bank account of a customer and are usually given to the customer while opening the bank account. Credit cards require substantial processing fees, while debit cards require availability of funds and sometimes involve surcharges as well. Typically, interchange and processing fees for a complete credit/debit card transaction may reach a significant amount.

At the same time, the customer typically visits a number of retails environments. Continuous carrying multiple retail cards (or other security/transactional devices) every time when visiting a retail environment of a merchant is inconvenient for the customer. Using a mobile payment service, the customer may save on processing fees, as well as may be able to pay any time without carrying cash or any credit cards, debit cards, gift cards, or checks.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are computer implemented methods and systems for facilitating mobile device payments using a mobile payment account. When a customer is ready to tender a payment to a merchant, instead of using a credit card, cash, or check, the customer activates an application on his mobile device associated with a mobile payment account of the user. The mobile payment account may be associated with a mobile payment service provider and created on a request of the user. The mobile payment account may be associated with user information provided by the user to the mobile payment service provider. The user information may include a name of the user, a social security number of the user, a phone number, an address, a bank account number, an insurance account number, a financial organization account number, and so forth. The mobile device may obtain information about the payment system of a merchant. Furthermore, the mobile device may generate a payment barcode that encodes data of the mobile payment account. The mobile device may display the payment barcode on a display. The displayed barcode may be scanned by a barcode scanner of the merchant and processed to retrieve data of the mobile payment account. Based on this data, a payment request may be generated and sent to the mobile payment service provider. The mobile payment service provider may then transfer funds from the mobile account of the user to the merchant.

In certain embodiments, a computer implemented method for facilitating mobile device payments using a mobile payment account may involve scanning a product code corresponding to the product item to retrieve product information and information about the payment system of this merchant. This operation may be performed using a mobile device.

In certain embodiments, a product code may include one or more of the following codes: a Unified Product Code (UPC) represented as a barcode and/or an alphanumeric string, an Electronic Product Code (EPC) encoded as a printed barcode or encoded on Radio Frequency Identification (RFID) tag, or any other variations of linear barcode, two dimensional barcodes, alphanumeric string (e.g., 8-bit, 16-bit, 32-bit string), electronically encoded codes (e.g., 96-bit strings).

Examples of mobile devices may include a cellular phone, a Personal Digital Assistant (PDA), a personal computer (e.g., a tablet or a laptop), a barcode scanner, and an RFID scanner. In general, any device that can be carried by a user into a retail environment, capable of retrieving one or more types of codes listed above, and capable of wirelessly communicating (e.g., via Wi-Fi network, 3G or 4G cellular network, or any other types of wireless communication networks) may be used. In certain embodiments, a mobile device may include a user interface for entering an alphanumeric entry corresponding to the product code. The same or another user interface may be used for entering authorization information.

Provided also is a system for facilitating mobile device payments using a mobile payment account. The system may comprise a processor configured to generate a payment barcode encoding data of the mobile payment account, to display the payment barcode on a display of a user mobile device; and to charge the mobile payment account. The mobile payment account may comprise funds stored in a form of a universal digital mobile currency. Additionally, the system may comprise a database in communication with the processor and configured to store data of the mobile payment account of the user. Optionally, the system may comprise a barcode scanner for scanning a payment barcode displayed on a display of the user mobile device. The displayed barcode may encode data of the mobile payment account. Additionally, the system may comprise a display in communication with the barcode scanner for displaying the data of the mobile payment account of the user.

Provided also is a computer-readable medium including instructions, which when executed by one or more processors, perform the following operations. In one operation, a payment barcode encoding data of a mobile payment account may be generated, the mobile payment account may be associated with the user information, and the mobile payment account may be associated with a mobile payment service provider. In another operation, the payment barcode scannable by a barcode scanner may be displayed on a display of the user mobile device. In yet other operations, the mobile payment account may be charged by transferring the funds from the mobile payment account to an account of a merchant.

In further exemplary embodiments, modules, subsystems, or devices can be adapted to perform the recited steps. Other features and exemplary embodiments are described below.

### BRIEF DESCRIPTION OF DRAWINGS

Embodiments are illustrated by way of example and not limitation in the figures of the accompanying drawings, in which like references indicate similar elements and in which:

FIG. 1 is a block diagram illustrating an example of the overall system in which various embodiments may be implemented.

FIG. 2 is a schematic representation of elements of a system for facilitating mobile device payments using a mobile payment account, in accordance with certain embodiments.

FIG. 3 is a flow chart illustrating a method for facilitating mobile device payments using a mobile payment account, in accordance with certain embodiments.

FIG. 4 is a block diagram showing various modules of a system for facilitating mobile device payments using a mobile payment account, in accordance with certain embodiments.

FIG. 5 is a schematic diagram illustrating an example of a computer system for performing any one or more of the methods discussed herein.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

Various computer implemented methods and systems for facilitating mobile device payments using mobile payment accounts are described herein. Recent proliferation of mobile devices (e.g., cell phones/smart phones and other similar devices) that are capable of generating and displaying various optical codes (e.g., barcodes) allows implementing these novel methods and systems. Most customers shopping in today's retail environments carry such mobiles devices. The systems described herein may be financial systems associated with mobile payment accounts, barcodes generated by a mobile device, a universal digital mobile currency, and mobile credits associated with the mobile payment accounts.

Upon providing user personal data via a user interface of the mobile device, a user may receive a mobile payment account from a mobile payment service provider. The mobile device may include a mobile phone, a personal digital assistant, a lap-top, a tablet PC, a smart phone, a wearable personal digital device, and so forth. The mobile payment account may be used for performing financial transactions, for example, for buying products or services. The mobile payment service provider may include any financial organization, such as a bank, an insurance company, and the like, that may provide the mobile payment account to the user upon receipt of the user information. The mobile payment service provider may be associated with chain stores, for example, Starbucks, and franchise organizations, such as McDonald's, to operate a large scale banking service of these organizations without bank charges.

The user information, provided to register a mobile payment account, may include a name of the user, a social security number of the user, a phone number, an address, a bank account number, an insurance account number, a financial organization account number, and the like. In some embodiments, the mobile payment account may not be associated with any credit card of the user. On the contrary, access to the mobile payment account may be given through the mobile device of the user, for example, by installing an application on the mobile device. The application may be associated with the data of the mobile payment account of the user and may communicate with the mobile payment service provider to update the data of the mobile payment account.

The user may access the mobile payment account any time and may perform any operations, such as pay for a product, transfer funds to a banking account or another mobile payment account, make a deposit to the mobile payment account, and so forth.

When the user is ready to tender a payment for products or services, instead of using a credit card, cash, or check, the user may activate an application on his mobile device. The mobile device may generate and display a barcode that encodes data of the mobile payment account.

The data of the mobile payment account may be stored in a memory unit of the user mobile device or a remote secure cloud server. Additionally, the data of the mobile payment account may be stored in a database of the mobile payment service provider. Upon a request of the user, the data of the mobile payment account may be displayed on a display of the user mobile device, for example, in a form of a barcode being scannable by a barcode scanner.

In some embodiments, information about a receiver of the payment may be sent to the mobile payment service provider by the receiver himself after he retrieves the data encoded in the payment barcode. In other embodiments, the information about the merchant may be obtained, for example, by product code scanning. Product codes are typically provided as barcodes, such as linear barcodes and two dimensional barcodes, as well as human readable alphanumeric code. Displaying a barcode may involve processing information to encode into a barcode image. The local processing may be performed using various software applications installed on the mobile device. For example, the Universal Product Code (UPC) or European Article Number (EAN) may be used. UPC is a barcode symbology widely used in North America and other countries for tracking trade items in stores. Its most common form, the UPC-A, consists of 12 numerical digits, which are uniquely assigned to each individual trade/product item. Each UPC-A barcode consists of a scannable strip of black bars and white spaces, above a sequence of 12 numerical digits. No letters, characters, or other content of any kind may appear on a standard UPC-A barcode. The digits and bars maintain a one-to-one correspondence. In other words, there is only one way to represent each 12-digit number visually, and there is only one way to represent each visual barcode numerically. EAN is another example developed as a superset of UPC and adding an extra digit to the beginning of every UPC number. EAN-13 barcodes also indicate the country in which the company that sells the product is based using leading digits. EAN and UPC barcodes are currently the only barcodes allowed for scanning trade/product items at the point of sale. However, other codes may be available in the future and within the scope of this document.

One having ordinary skills in the art would understand that the term “scanning” is not limited to printed codes having particular formats but can be used for codes encoded electronically and using various other means. For example, product codes may be in the form of the recently developed Electronic Product Code (EPC) designed as a universal identifier that provides a unique identity for every physical object (not just a trade item category) anywhere in the world. It should be noted that EPCs are not exclusively used with RFID data carriers. They can be constructed based on reading of optical data carriers, such as linear bar codes and two-dimensional bar codes, such as Data Matrix symbols. For purposes of this document, all optical data carriers are referred herein as “barcodes.”

Scanning a barcode may involve capturing an image of the barcode using a simple imaging device installed on a mobile device, such as a digital camera. The image may be then processed on the mobile device to retrieve corresponding product information or sent to the server for further processing. The local processing may be performed using various software installed on the mobile device. In certain embodiments, a mobile device may contain a local database to match the retrieved product information with additional information about this product. However, because of variable nature of this additional information (e.g., pricing, product description), a mobile device then typically transmits the retrieved product information to the server and then receives some additional information from the server.

In some embodiments, funds may be stored on the mobile payment account in a form of universal digital mobile currency. The universal digital mobile currency may be created by the mobile payment service provider. In other embodiments, one or more of conventional virtual money systems may be used as the universal digital mobile currency. The universal digital mobile currency may be used in various operations performed with mobile payment account, for example, users of the system for facilitating mobile device payments may transfer funds to each other in the universal digital mobile currency, may pay for products or services, for example, in on-line gaming systems for buying virtual products in on-line games, and so forth.

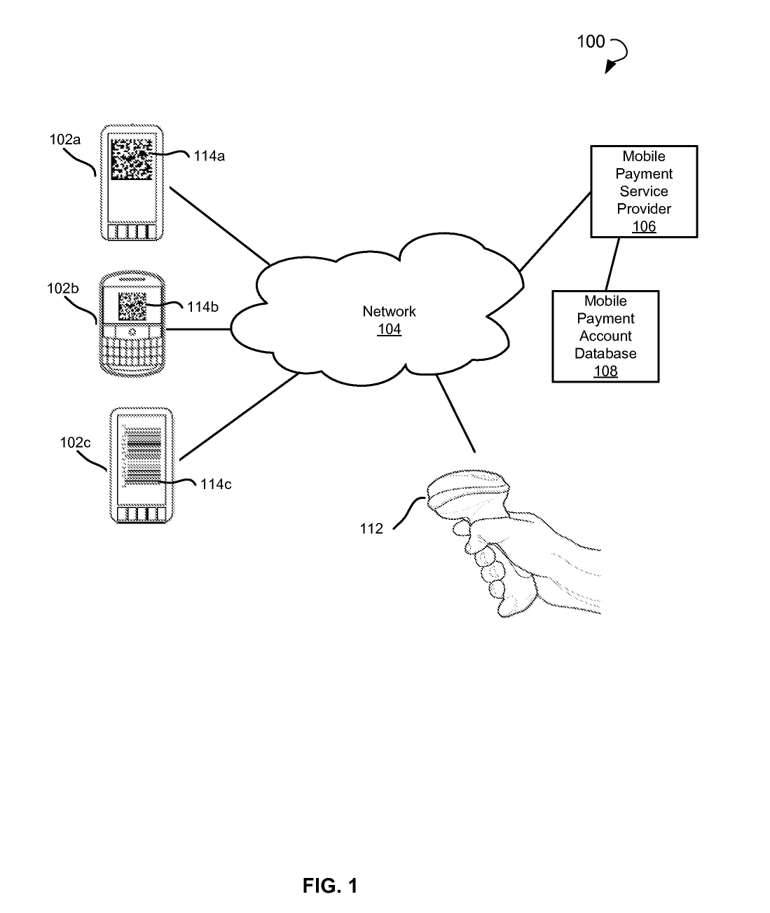

The methods described herein may be performed by any mobile devices with wireless communication capabilities. In addition to being capable of transmitting voice-based signals, many modern cell phones have internet connectivity using cellular networks (e.g., 3G, 4G) as well as Wi-Fi and other types of networks. Some additional examples of such networks are described below with reference to FIG. 1. Wireless communication may be used to transmit retrieved product information to a payment server, receive replies, and transmit authorizations. Overall, various data may be exchanged between the mobile and payment server as well as other servers during operations of the method.

Before describing various methods and associated operations, a brief description of a computer network is described. Specifically, FIG. 1 illustrates an example network segment 100 for implementing various aspects of methods and operations for facilitating mobile device payments using a mobile device. As shown, multiple mobile devices 102a, 102b, 102c may be configured to display barcodes 114a, 114b, 114c. Various examples of barcodes are described above. The barcodes displayed by the mobile devices 102a, 102b, 102c may be scannable by a barcode scanner 112, or another mobile device. Mobile devices 102a, 102b, 102c may communicate with a mobile payment service provider 106 via a network 104. The mobile payment service provider 106 may include a mobile payment account database 108. The network 104 may be also used for communication among various components of the system for facilitating mobile device payments. The network 104 may take any suitable form, such as a wide area network or Internet and/or one or more local area networks (LAN's). The network 104 may include any suitable number and type of devices, e.g., routers and switches, for forwarding commands, content, and/or web object requests from each client to the online community application and responses back to the clients.

The methods described herein may also be practiced in a wide variety of network environments (represented by the network 104) including, for example, TCP/IP-based networks, telecommunications networks, wireless networks, etc. In addition, the computer program instructions may be stored in any type of computer-readable media. The program may be executed according to a variety of computing models including a client/server model, a peer-to-peer model, on a stand-alone computing device, or according to a distributed computing model in which various functionalities described herein may be effected or employed at different locations.

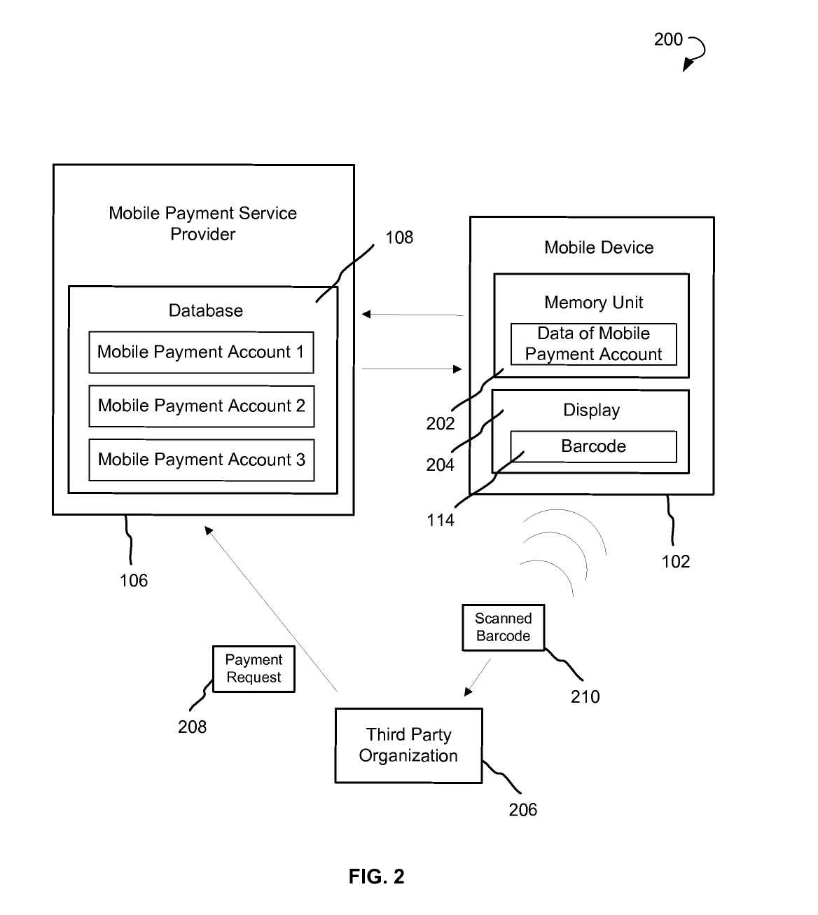

FIG. 2 schematically shows elements of a system 200 for facilitating mobile device payments using a mobile payment account, in accordance with certain embodiments. A mobile payment service provider 106 may comprise a database 108 that stores data of the mobile payment accounts of the users. The mobile payment service provider 106 may communicate with a mobile device 102 of the user. The mobile device 102 may comprise a memory unit 202 that stores data of the mobile payment account of the user. Additionally, the mobile device may comprise a display 204 configurable to display barcodes. The user may give a command to generate a payment barcode 114 associated with the mobile payment account on the display 204 of the mobile device 102. The payment barcode 114 may be scanned by a barcode scanner of a third party organization 206 or by another mobile device. The third party organization 206 may be an organization providing products or services for which the user wishes to pay. After scanning the payment barcode, the third party organization 206 may send a payment request 208 to the mobile payment service provider 106. After retrieving the data of the mobile payment account from the scanned barcode 210, the mobile payment service provider 106 may charge the mobile payment account by transferring funds from the mobile payment account to the account of the third party organization 206.

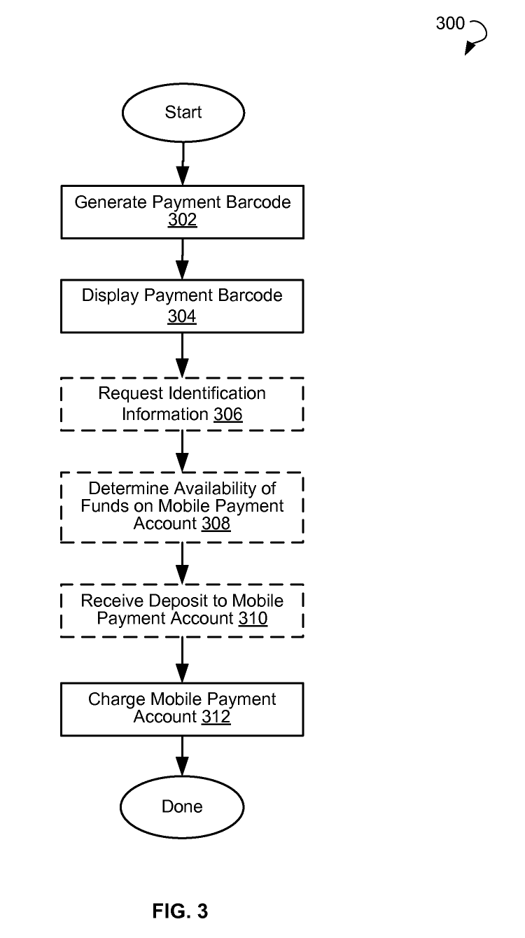

FIG. 3 is a flow chart illustrating a method for facilitating mobile device payments using a mobile payment account, in accordance with certain embodiments. Method 300 may start with generating, by a processor of a user mobile device, on a request of a user, a payment barcode in operation 302. The payment barcode may encode data of the mobile payment account of the user. The mobile payment account may be associated with user information and with the mobile payment service provider to which the user provided the user information. The user information may include a name of the user, a social security number of the user, a phone number, an address, a bank account number, an insurance account number, a financial organization account number, and the like. The data of the mobile payment account may be stored on the mobile device. Additionally, the user information associated with the mobile payment account may be stored in a database of the mobile payment service provider.

In some embodiments, before giving a request to generate the payment barcode, the mobile device may be used to capture an image of the product barcode. This image may be then processed by the mobile device to retrieve product information (e.g., UPC or EAN code) encoded in the product code. The product barcode may encode the product information and the information about a payment system of a merchant providing the product. The information encoded in the product barcode and the data of the mobile payment account stored on the mobile device may be used for generating the payment barcode.

Method 300 may proceed with displaying the payment barcode on a display of the user mobile device in operation 304. The displayed payment barcode may be scannable by a barcode scanner. The barcode scanner may include a checkout scanner, a check-in scanner, a mobile device, a wearable personal device, and so forth. The payment barcode displayed on the display of the mobile device may be a linear barcode, a two-dimensional barcode, a three-dimensional barcode, or any other machine readable code.

In certain embodiments, method 300 may include an optional operation 306 that involves requesting identification information to authorize access to the mobile payment account via the interface of the user mobile device. The identification information may include a password, a Personal Identification Number (PIN) code, and biometric authorization including fingerprint scanning, palm scanning, face scanning, and retina scanning. The scanning may be performed using the one or more biometric sensors of the mobile device.

Method 300 may optionally involve determining availability of funds on the mobile payment account in operation 308. The user may give a request by the interface of the mobile device to display the amount of funds available on the mobile payment account. After receiving such request, the mobile payment service provider may transmit the information about the available funds to the mobile device. Then, the data about the amount of funds available on the mobile payment account may be displayed on the display of the mobile device. Alternatively, data of the mobile payment account retrieved from the scanned payment barcode may be used to determine availability of funds.

Method 300 may also optionally involve receiving a deposit to the mobile payment account in operation 310. The user may put the deposit to the mobile payment account via a cash-in automatic transaction machine (ATM), a bank transfer, a transfer from another mobile payment account, and the like. In an example embodiment, the deposit to the mobile payment account may be received using mobile currency.

Finally, method 300 may also involve charging the mobile payment account in operation 312. The mobile payment account may be charged based on a payment request received from a payment receiver. The payment request may be associated with the data of the mobile payment account retrieved from the payment barcode. The funds may be transferred from the mobile payment account of the user to the account of the merchant (receiver). This operation may also involve updating the data of the mobile payment account based on the transferred payment amount.

In some embodiments, the funds may be stored on the mobile payment account in a form of universal digital mobile currency. The universal digital mobile currency may be a digital currency (paper-less, contact-less, and non-physical) enabling instant payments between users, for example, a seller and a buyer, anytime and anywhere in the world. With the universal digital mobile currency, involvement of financial institution, and associated fees and charges, may be avoided. The universal digital mobile currency is issued and managed via mobile devices or mobile networks. The universal digital mobile currency may be stored on the user mobile device or an on-line wallet, transmitted and received in a peer-to-peer manner via the user mobile device, an on-line resource, and mobile device application. The universal digital mobile currency may be owned, transferred, purchased, and sold by the user virtually or in real life.

To protect users, the mobile payment service provider may set limits on operations in the universal digital mobile currency, the limits including a limit for a pre-determined period, a number of transactions limit, and a maximum amount per transaction.

Additionally, the universal digital mobile currency stored on a user device maybe encrypted, for example, using high standard encryption that is used in military and government applications. Moreover, payments in the universal digital mobile currency may be protected by a digital signature and a password. Thus, risk of fraud, chargeback, and identity theft associated with Internet payments may be eliminated.

In some embodiments, the universal digital mobile currency may be handled using an interface associated with an on-line wallet, the user mobile device. History of transactions in the universal digital mobile currency is stored in a network. Additionally, the use of the universal digital mobile currency allows eliminating the need for PCI compliance and expensive security measures.

In some embodiments, the mobile payment service provider may provide micro credit loans, payday loans, long-term loans and short-term loans in the universal digital mobile currency.

Thus, the user mobile device may perform a function of a point of sale terminal using the universal digital mobile currency. The user mobile device may become a bank terminal, and the user a 24 hour full time banker.

The mobile payment service provider may set an exchange rate for the universal digital mobile currency with respect to one or more official state currencies. The universal digital mobile currency may be not controller by any national government.

In some embodiments, a transfer from the mobile payment account of the user to an account of the merchant or another mobile payment account may be performed in the universal digital mobile currency. Additionally, funds transfers in the universal digital mobile currency may be performed to other types of accounts, for example, to the account of the user in an on-line gaming system.

In some embodiments, the universal digital mobile currency may be a decentralized universal digital currency based on mobile devices and peer-to-peer internet protocol. The universal digital currency may be exchanged to an official state currency based on an exchange rate set by the mobile payment service provider without an intermediate financial institution.

The universal digital mobile currency may be issued by a universal digital mobile currency bank that may be a virtual bank holding a deposit of the user. An issue volume of the universal digital mobile currency may be a percentage of a total transaction volume of the universal digital mobile currency bank. A percentage and an annual issue of the universal digital mobile currency may be calculated based on analysis of a number of factors including at least one or a combination of: transaction volume, transaction growth, deposit to expense ratio, total deposit to total transaction ratio, user quantity, virtual loan per a person, virtual debt per a person, universal digital mobile currency issue per a person, default risk, and liquidation capacity.

In some embodiments, the mobile payment account may be accessible on platforms iOS, Android, Windows, Linux, Unix, and so forth using a smartphone, a wearable personal digital device, a game console, a personal computer, a tablet personal computer, and a car computer. A non-cash deposit to the mobile payment account may be made by means of a mobile phone, a personal computer, and a wearable personal digital device. A cash deposit to the mobile payment account may be made at a place of the mobile payment service provider.

The password allowing an access to the universal digital mobile currency may be in a form of a alphanumeric character, a voice, a scrambled image, a video clip, a gesture of any part of a body. The password may be entered by means of a touch screen, a keyboard, a mouse, or a camera of the mobile device or by means of a remote control of the mobile device.

In some embodiments, the universal digital mobile currency may be a digital currency enabling to perform a payment to any person at any time and any place. The universal digital mobile currency may be a peer-to-peer electronic digital currency enabling to send mobile device payments or on-line payments directly without a financial institution. Use of the universal digital mobile currency may eliminate the risk of a fraud, a chargeback, and an identity theft. The universal digital mobile currency may be exchanged by means of the mobile device using a national currency exchange rate or a virtual wallet. To perform or verify a transaction, the universal digital mobile currency may be accessed via a virtual wallet interface or a cloud server. To each transaction in the universal digital mobile currency a transaction fee may be applied.

In some embodiments, the mobile device payments may be performed using wireless communication, such as a wi-fi communication. The mobile device payments may include person-to-person, business-to-business, person-to-business, and business-to-person financial transactions. The mobile payment service provider may issue a payment barcode encoding payment card information. A payment card may include a credit card, a debit card, a gift card, a discount card, and a coupon card.

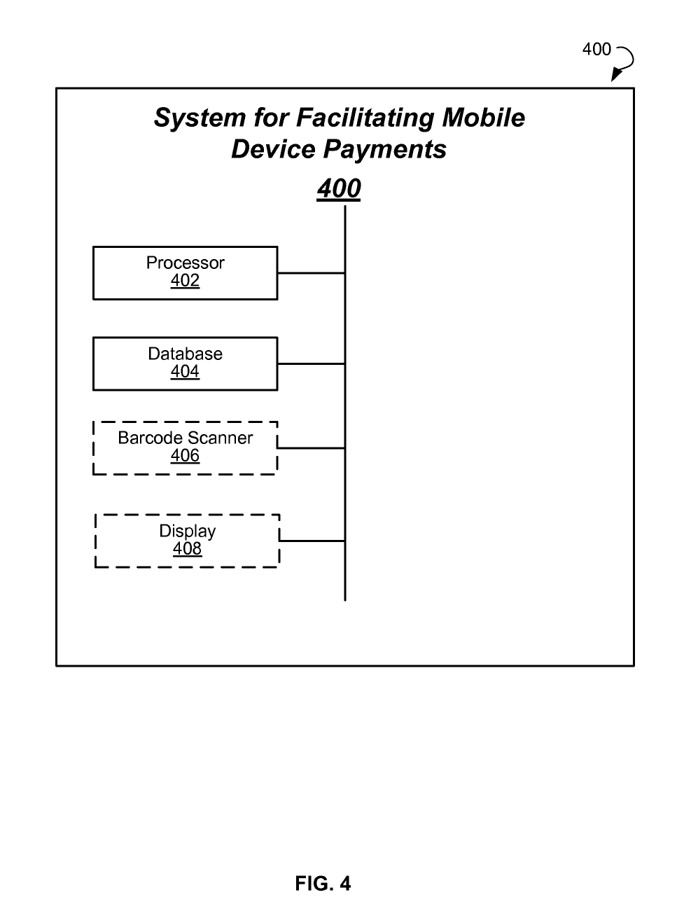

FIG. 4 is a block diagram showing various modules of system 400 for facilitating mobile device payments using a mobile payment account, in accordance with certain embodiments. Specifically, system 400 may include a processor 402 for generating a payment barcode encoding data of the mobile payment account, displaying the payment barcode on a display of a user mobile device and charging the mobile payment account. In certain embodiments, system 400 may include a database 404 in communication with the processor for storing data of the mobile payment account of the user. System 400 may optionally include a barcode scanner 406 for scanning a payment barcode displayed on a display of a mobile device. The barcode scanner may include a camera or a special-purpose device for barcode scanning. The displayed barcode may encode data of the mobile payment account. System 400 may also optionally include a display 408 for displaying the data of the mobile payment account of the user. In certain embodiments, display 408 may be provided at a device of a payment receiver.

In some embodiments, the processor 402 may generate a receipt barcode, the receipt barcode being scannable by a barcode scanner or a user device. On the scan, a refund operation may be initiated.

Another possible embodiment of the present disclosure may be a mobile payment device for mobile device payments using a mobile payment account. The mobile payment device may comprise a processor configured to generate a payment barcode or receive the payment barcode from an on-line resource. The payment barcode may encode data of the mobile payment account.

The generated or received payment barcode may be displayed on a display of the mobile payment device. The displayed barcode may be scanned by a barcode scanner or a user device. The barcode may encode transaction information and information about a mobile payment account of the user. The information about the mobile payment account and/or transaction information may be stored in a memory unit. The mobile payment account may be associated with the user information.

Provided also is a system for mobile payments between a seller and a buyer. The system may comprise a seller device, a buyer device, and a server of a mobile service provider.

The seller device may comprise a processor configured to generate a payment barcode. The payment barcode may encode data of the mobile payment account of the seller and/or transaction information. The generated barcode may be displayed on a display seller device. The displayed payment barcode may be scanned the buyer device.

The seller device may further comprise a memory unit configured to store transaction information and data of the mobile payment account of the seller. The mobile payment account may be associated with seller information.

The buyer device may comprise a camera configured to capture an image of the payment barcode displayed, for example on the display of the seller device. The image of the payment barcode may be processed by a processor of the buyer device and the transaction information and/or data of the mobile payment account of the seller may be extracted from the image and transmitted the mobile service provider. In some embodiments, the extracted information may be displayed on a display of the buyer device.

The server of the mobile service provider may comprise a processor configured to receive the transaction information and charge a mobile payment account of the buyer based on the transaction information. Information associated with the mobile payment account of the seller and the mobile payment account of the buyer may be stored in a database of the server of the mobile service provider.

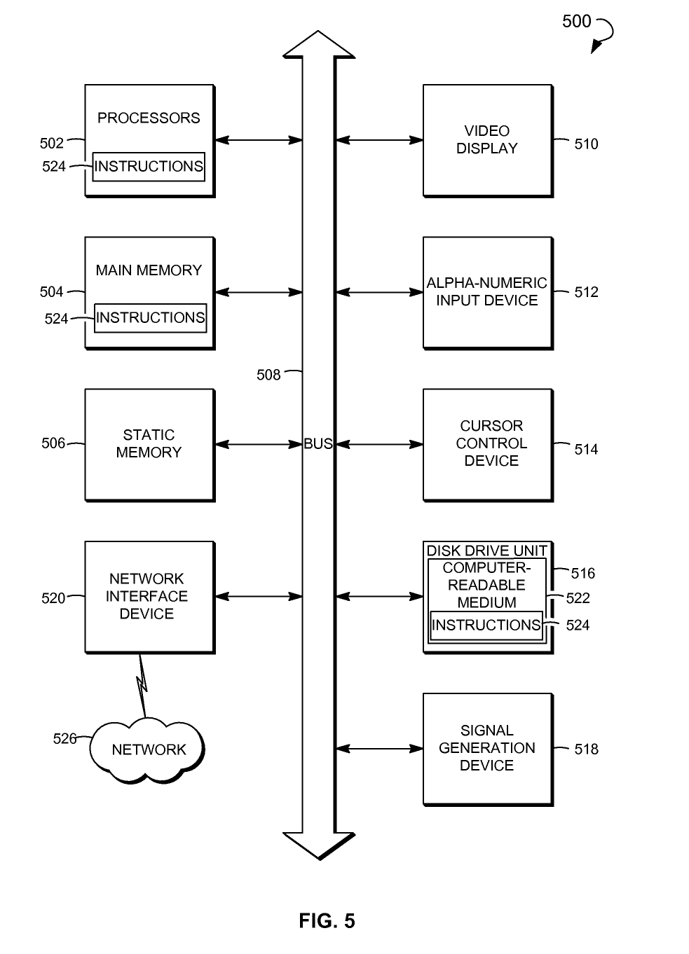

FIG. 5 shows a diagrammatic representation of a machine in the example electronic form of a computer system 500, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor or multiple processors 502 (e.g., a central processing unit (CPU), a graphics processing unit (GPU), or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 may also include an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 includes a computer-readable medium 522, on which is stored one or more sets of instructions and data structures (e.g., instructions 524) embodying or utilized by any one or more of the methodologies or functions described herein. The instructions 524 may also reside, completely or at least partially, within the main memory 504 and/or within the processors 502 during execution thereof by the computer system 500. The main memory 504 and the processors 502 may also constitute machine-readable media.

The instructions 524 may further be transmitted or received over a network 526 via the network interface device 520 utilizing any one of a number of well-known transfer protocols (e.g., Hyper Text Transfer Protocol (HTTP)).

While the computer-readable medium 522 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein may be implemented in an operating environment comprising software installed on a computer, in hardware, or in a combination of software and hardware.

Thus, various systems and methods for facilitating mobile device payments using a mobile payment account have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

1. A computer implemented method for facilitating mobile device payments using a mobile payment account, the method comprising:
generating, by a processor of a user mobile device, on a request of a user, a payment barcode, the payment barcode encoding data of the mobile payment account, wherein the mobile payment account is associated with user information, and wherein the mobile payment account is associated with a mobile payment service provider;
displaying the payment barcode on a display of the user mobile device, the displayed payment barcode being scannable by a barcode scanner or a further mobile device; and
charging the mobile payment account.

2. The computer implemented method of claim 1, wherein the mobile payment account is charged based on a payment request.

3. The computer implemented method of claim 2, wherein the payment request is associated with the data of the mobile payment account retrieved from the payment barcode.

4. The computer implemented method of claim 1, wherein the data of the mobile payment account is stored on the user mobile device or a remote secure cloud server.

5. The computer implemented method of claim 1, wherein the barcode scanner includes a checkout scanner, a check-in scanner, a mobile device, and a wearable personal device.

6. The computer implemented method of claim 1, wherein the mobile payment service provider includes a financial organization, a bank, an insurance company, and any other merchant.

7. The computer implemented method of claim 1, wherein the user information includes one or more of the following: a name of the user, a social security number of the user, a phone number, an address, a bank account number, an insurance account number, and a financial organization account number.

8. The computer implemented method of claim 1, further comprising requesting identification information to authorize access to the mobile payment account via the interface of the user mobile device.

9. The computer implemented method of claim 8, wherein the identification information includes a password, a Personal Identification Number (PIN) code, and biometric authorization, the biometric authorization including fingerprint scanning, palm scanning, face scanning, and retina scanning, wherein the scanning is performed using the one or more biometric sensors.

10. The computer implemented method of claim 1, further comprising receiving a deposit to the mobile payment account via a cash-in automatic transaction machine (ATM), a bank transfer, or a transfer from another mobile payment account using mobile currency.

11. The computer implemented method of claim 1, wherein the user mobile device includes a mobile phone, a personal digital assistant, a lap-top, a tablet personal computer, a smart phone, and a wearable personal digital device.

12. The computer implemented method of claim 1, wherein the payment barcode is a linear barcode, a two-dimensional barcode, a three-dimensional barcode, or other machine readable code.

13. The computer implemented method of claim 1, further comprising determining availability of funds on the mobile payment account.

14. The computer implemented method of claim 1, wherein the user information associated with the mobile payment account is stored in a database of the mobile payment service provider.

15. The computer implemented method of claim 1, wherein funds are stored on the mobile payment account in a form of universal digital mobile currency.

16. The computer implemented method of claim 15, wherein the mobile payment service provider sets an exchange rate for the universal digital mobile currency with respect to one or more official state currencies, the universal digital mobile currency being uncontrolled by a national government.

17. The computer implemented method of claim 15, wherein a transfer from the mobile payment account of the user to another mobile payment account is performed in the universal digital mobile currency.

18. The computer implemented method of claim 15, further comprising transferring an amount in the universal digital mobile currency from the mobile payment account of the user to an account of the user in an on-line gaming system.

19. The computer implemented method of claim 1, wherein the mobile payment service provider is associated with a chain store and a franchise organization.

20. A system for facilitating mobile device payments using a mobile payment account, the system comprising:
a processor configured to:
generate a payment barcode, the payment barcode encoding data of the mobile payment account;
display the payment barcode on a display of a user mobile device;
charge the mobile payment account; and
a database in communication with the processor and configured to store data of the mobile payment account of a user, wherein the mobile payment account is associated with the user information.

21. The system for facilitating mobile device payments of claim 20, the system further comprising:
a barcode scanner for scanning a payment barcode displayed on a display of the user mobile device, wherein the displayed barcode encodes data of the mobile payment account; and
a display for displaying the data of the mobile payment account of the user, the display being provided at the barcode scanner.

22. The system for facilitating mobile device payments of claim 20, wherein the mobile payment account comprises funds stored in a form of universal digital mobile currency, and wherein the system is a financial system associated with the mobile payment account, barcodes generated by the mobile device, the universal digital mobile currency, and mobile credits.

23. The system for facilitating mobile device payments of claim 22, wherein the universal digital mobile currency is a digital currency.

24. The system for facilitating mobile device payments of claim 22, wherein the universal digital mobile currency is issued and managed via mobile devices or mobile networks.

25. The system for facilitating mobile device payments of claim 22, wherein the universal digital mobile currency is transmitted in a peer-to-peer manner without including a financial institution.

26. The system for facilitating mobile device payments of claim 22, wherein the universal digital mobile currency is stored on the user mobile device or an on-line wallet, the universal digital mobile currency being encrypted.

27. The system for facilitating mobile device payments of claim 22, wherein the user mobile device performs a function of a point of sale terminal using the universal digital mobile currency.

28. The system for facilitating mobile device payments of claim 22, wherein the user mobile device performs a function of payment cards terminal using the universal digital mobile currency.

29. The system for facilitating mobile device payments of claim 22, wherein the universal digital mobile currency is a decentralized universal digital currency based on mobile devices and peer-to-peer internet protocol.

30. The system for facilitating mobile device payments of claim 22, wherein the universal digital mobile currency is exchanged to an official state currency based on an exchange rate set by a mobile payment service provider without an intermediate financial institution.

31. The system for facilitating mobile device payments of claim 22, wherein the universal digital mobile currency is transmitted and received via the user mobile device, an on-line resource, and mobile device application.

32. The system for facilitating mobile device payments of claim 22, wherein the universal digital mobile currency is handled using an interface associated with an on-line wallet, the user mobile device.

33. The system for facilitating mobile device payments of claim 22, wherein payments in the universal digital mobile currency are protected by a digital signature and a password.

34. The system for facilitating mobile device payments of claim 22, wherein history of transactions in the universal digital mobile currency is stored in a network.

35. The system for facilitating mobile device payments of claim 22, wherein the universal digital mobile currency is paper-less, contact-less, and non-physical money.

36. The system for facilitating mobile device payments of claim 22, wherein the mobile payment service provider provides micro credit loans, payday loans, long-term loans and short-term loans in the universal digital mobile currency.

37. The system for facilitating mobile device payments of claim 22, wherein the universal digital mobile currency is owned, transferred, purchased, and sold by the user virtually or in real life.

38. The system for facilitating mobile device payments of claim 22, wherein the mobile payment service provider sets limits on operations in the universal digital mobile currency, the limits including a limit for a pre-determined period, a number of transactions limit, and a maximum amount per transaction.

39. The system for facilitating mobile device payments of claim 20, wherein the processor is further configured to generate a receipt barcode, the receipt barcode being scannable and, on the scan, initiating a refund operation.

40. The system for facilitating mobile device payments of claim 22, wherein the universal digital mobile currency is issued by a universal digital mobile currency bank, the universal digital mobile currency bank being a virtual bank holding a deposit of the user.

41. The system for facilitating mobile device payments of claim 40, wherein an issue volume of the universal digital mobile currency is a percentage of a total transaction volume of the universal digital mobile currency bank.

42. The system for facilitating mobile device payments of claim 41, wherein a percentage and an annual issue of the universal digital mobile currency is calculated based on analysis of at least one or a combination of: transaction volume, transaction growth, deposit to expense ratio, total deposit to total transaction ratio, user quantity, virtual loan per a person, virtual debt per a person, universal digital mobile currency issue per a person, default risk, and liquidation capacity.

43. The system for facilitating mobile device payments of claim 20, wherein the mobile payment account is accessible on platforms iOS, Android, Windows, Linux, and Unix.

44. The system for facilitating mobile device payments of claim 20, wherein the mobile payment account is accessible on a smartphone, a wearable personal digital device, a game console, a personal computer, a tablet personal computer, and a car computer.

45. The system for facilitating mobile device payments of claim 20, wherein a non-cash deposit to the mobile payment account is made by means of a mobile phone, a personal computer, and a wearable personal digital device, and wherein a cash deposit to the mobile payment account is made at a place of the mobile payment service provider.

46. The system for facilitating mobile device payments of claim 33, wherein the password is in a form of a alphanumeric character, a voice, a scrambled image, a video clip, a gesture of any part of a body, and wherein the password is entered by means of a touch screen, a keyboard, a mouse, or a camera of the mobile device or by means of a remote control of the mobile device.

47. The system for facilitating mobile device payments of claim 22, wherein the universal digital mobile currency is a digital currency enabling performing the payment to any person at any time and at any place.

48. The system for facilitating mobile device payments of claim 22, wherein the universal digital mobile currency is a peer-to-peer electronic digital currency enabling to send mobile device payments or on-line payments directly without a financial institution.

49. The system for facilitating mobile device payments of claim 22, wherein the universal digital mobile currency eliminates the risk of a fraud, a chargeback, and an identity theft.

50. The system for facilitating mobile device payments of claim 22, wherein the universal digital mobile currency is exchanged by means of the mobile device using a national currency exchange rate or a virtual wallet.

51. The system for facilitating mobile device payments of claim 22, wherein a transaction fee is applied to each transaction in the universal digital mobile currency.

52. The system for facilitating mobile device payments of claim 22, wherein the universal digital mobile currency is accessed via a virtual wallet interface or a cloud server.

53. The system for facilitating mobile device payments of claim 20, wherein the mobile device payments are performed using wireless communication, wherein the wireless communication includes a wi-fi communication.

54. The system for facilitating mobile device payments of claim 20, wherein the mobile device payments include person-to-person, business-to-business, person-to-business, and business-to-person financial transactions.

55. The system for facilitating mobile device payments of claim 20, wherein a mobile payment service provider issues a payment barcode encoding payment card information, wherein a payment card includes a credit card, a debit card, a gift card, a discount card, and a coupon card.

56. The system for facilitating mobile device payments of claim 21, wherein the payment barcode is a linear barcode, a two-dimensional barcode, a three-dimensional barcode, or other machine readable code.

57. A mobile payment device for mobile device payments using a mobile payment account, the device comprising:
a processor configured to generate a payment barcode or receive the payment barcode from an on-line resource, wherein the payment barcode encodes data of the mobile payment account;
a display to display the payment barcode, the payment barcode being scannable by a barcode scanner or a user device;
a camera configured to capture an image of a barcode;
a memory unit configured to store transaction information and data of the mobile payment account of a user, wherein the mobile payment account is associated with the user information.

58. A system for mobile payments between a seller and a buyer, the system comprising:
a seller device comprising:
a processor configured to generate a payment barcode, the payment barcode encoding data of the mobile payment account of the seller;
a display configured to display the payment barcode, the payment barcode being scannable by a buyer device;
a memory unit configured to store transaction information and data of the mobile payment account of the seller, wherein the mobile payment account is associated with seller information;
the buyer device comprising:
a camera configured to capture an image of the payment barcode;
a processor configured to process the image of the payment barcode, extract the transaction information from the image, and transmit the transaction information to a mobile service provider;
a display to display the transaction information;
a server of the mobile service provider comprising:
a processor configured to receive the transaction information and charge a mobile payment account of the buyer based on the transaction information;
a database configured to store information associated with the mobile payment account of the seller and the mobile payment account of the buyer.

59. A non-transitory computer-readable medium comprising instructions, which when executed by one or more processors, perform the following operations:
generate a payment barcode, the payment barcode encoding data of the mobile payment account, wherein the mobile payment account is associated with the user information, and wherein the mobile payment account is associated with a mobile payment service provider;
display the payment barcode on a display of the user mobile device, the displayed payment barcode being scannable by a barcode scanner; and
charging the mobile payment account.
